(19) United States
(12) Patent Application Publication
(10) Pub. No.: US 2020/0400228 A1
(43) Pub. Date: Dec. 24, 2020

(54) POWER TRANSMISSION DEVICE

(71) Applicant: NISSAN MOTOR CO., LTD., Yokohama-shi, Kanagawa (JP)

(72) Inventors: Kouichi KOTSUJI, Numazu-shi, Shizuoka (JP); Tomoyuki NAKANO, Kanagawa (JP); Ryohey TOYOTA, Kanagawa (JP)

(73) Assignee: NISSAN MOTOR CO., LTD., Yokohama-shi, Kanagawa (JP)

(21) Appl. No.: 16/958,242

(22) PCT Filed: Dec. 20, 2018
(86) PCT No.: PCT/JP2018/047108

§ 371 Date: Jun. 26, 2020

(30) Foreign Application Priority Data
Dec. 28, 2017 (JP) 2017-254753

(51) Int. Cl. F16H 61/00; F16H 61/662

(52) U.S. Cl. CPC F16H 61/0031; F16H 61/12; F16H 61/66272

(57) ABSTRACT

A power transmission device includes a variator, a first oil passage, an electric oil pump provided in the first oil passage, a second oil passage, a switching valve provided at a branch point of the first oil passage and the second oil passage, and a third oil passage. The switching valve switches between two positions, i.e. a first position that causes at least the first oil passage to be in a communicating state, and a second position that causes the second oil passage and the first oil passage on a SEC pulley oil chamber side to be in a state of communicating with each other and causes the third oil passage and the first oil passage on a PRI pulley oil chamber side to be in a state of communicating with each other.

### TECHNICAL FIELD

The present invention relates to a power transmission device.

### BACKGROUND ART

JP2005-30495A discloses a shift drive device including a continuously variable transmission, a clutch, a mechanical oil pump, and an electric oil pump.

The mechanical oil pump is driven by an engine and configured to be able to supply oil in an oil reservoir to a secondary pulley oil chamber of the continuously variable transmission and to the clutch. The electric oil pump is provided in an oil passage communicating between a primary pulley oil chamber and the secondary pulley oil chamber of the continuously variable transmission, and is configured to be able to supply the oil in the oil reservoir to the clutch. The shift of the continuously variable transmission is performed by supplying and discharging the oil to and from the primary pulley oil chamber by the electric oil pump.

### SUMMARY OF INVENTION

In the technique of JP2005-30495A, when supplying the oil in the oil reservoir to the clutch by the electric oil pump, the oil passage communicating between the primary pulley oil chamber and the secondary pulley oil chamber and provided with the electric oil pump, specifically the oil passage communicating between the primary pulley oil chamber and the electric oil pump, is set to a blocked state by a switching valve. As a result, with the technique of JP2005-30495A, it is not possible to perform a shift of the continuously variable transmission in this event. Consequently, there is a possibility that, for example, the speed ratio of the continuously variable transmission is not properly set at the restart after the automatic stop of the engine, leading to a reduction in the starting performance or the re-acceleration performance of a vehicle.

The present invention has been made in view of such problems and has an object to provide a power transmission device that enables a shift of a continuously variable transmission mechanism even when oil in an oil reservoir is supplied to a hydraulic device other than the continuously variable transmission mechanism by an electric oil pump.

A power transmission device according to a certain aspect of the present invention includes a continuously variable transmission mechanism configured to perform power transmission between a drive source and a drive wheel, a first oil passage communicating between a primary pulley oil chamber of the continuously variable transmission mechanism and a secondary pulley oil chamber of the continuously variable transmission mechanism, an electric oil pump provided in the first oil passage, a second oil passage branching from the first oil passage between the electric oil pump and the primary pulley oil chamber and communicating with an oil reservoir, a switching valve provided at a branch point of the first oil passage and the second oil passage, and a third oil passage branching from the first oil passage between the electric oil pump and the secondary pulley oil chamber and reaching the switching valve. The switching valve is configured to switch between two positions. The two positions are a first position that causes at least the first oil passage to be in a communicating state, and a second position that causes the second oil passage and the first oil passage on a secondary pulley oil chamber side to be in a state of communicating with each other and causes the third oil passage and the first oil passage on a primary pulley oil chamber side to be in a state of communicating with each other.

### BRIEF DESCRIPTION OF DRAWINGS

FIG. 1 is a schematic configuration diagram illustrating the main part of a vehicle.

FIG. 2A is a first diagram of a diagram for explaining a switching position of a switching valve.

FIG. 2B is a second diagram of the diagram for explaining a switching position of the switching valve.

FIG. 3 is a diagram in the form of a flowchart illustrating one example of control at the time of automatic stop of an engine.

FIG. 4 is a diagram in the form of a flowchart illustrating one example of control at the time of automatic stop return of the engine.

FIG. 5 is a diagram illustrating a modification of a power transmission device.

### DESCRIPTION OF EMBODIMENTS

An embodiment of the present invention will be described below with reference to the accompanying drawings.

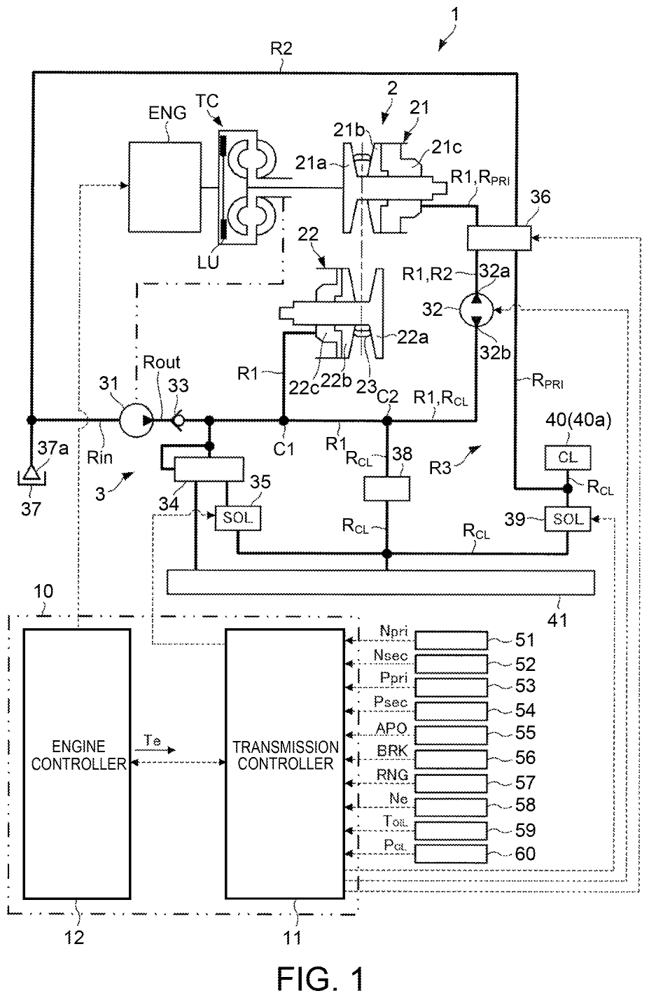

FIG. 1 is a schematic configuration diagram illustrating the main part of a vehicle. A transmission 1 is a belt continuously variable transmission and is mounted on the vehicle along with an engine ENG forming a drive source of the vehicle. The rotation from the engine ENG is input to the transmission 1. The output rotation of the engine ENG is input to the transmission 1 via a torque converter TC including a lockup clutch LU, and so on. The transmission 1 outputs the input rotation at the rotation corresponding to the speed ratio. The speed ratio is a value obtained by dividing the input rotation by the output rotation.

The transmission 1 includes a variator 2 and a hydraulic circuit 3.

The variator 2 is provided in a power transmission path connecting the engine ENG and non-illustrated drive wheels and performs the power transmission between them. The variator 2 is a belt continuously variable transmission mechanism including a primary pulley 21, a secondary pulley 22, and a belt 23 wound between the primary pulley 21 and the secondary pulley 22.

The variator 2 performs a shift by changing the groove widths of the primary pulley 21 and the secondary pulley 22 to change the winding diameters of the belt 23. Hereinafter, primary will be referred to as PRI, and secondary will be referred to as SEC.

The PRI pulley 21 includes a fixed pulley 21a, a movable pulley 21b, and a PRI pulley oil chamber 21c. In the PRI pulley 21, the oil is supplied to the PRI pulley oil chamber 21c. When the movable pulley 21b is moved by the oil in the PRI pulley oil chamber 21c, the groove width of the PRI pulley 21 is changed.

The SEC pulley 22 includes a fixed pulley 22a, a movable pulley 22b, and a SEC pulley oil chamber 22c. In the SEC pulley 22, the oil is supplied to the SEC pulley oil chamber 22c. When the movable pulley 22b is moved by the oil in the SEC pulley oil chamber 22c, the groove width of the SEC pulley 22 is changed.

The belt 23 is wound on a sheave surface of a V-shape formed by the fixed pulley 21a and the movable pulley 21b of the PRI pulley 21 and on a sheave surface of a V-shape formed by the fixed pulley 22a and the movable pulley 22b of the SEC pulley 22. The belt 23 is held by a belt clamping force generated by a SEC pressure Psec.

The hydraulic circuit 3 includes, in addition to the PRI pulley oil chamber 21c and the SEC pulley oil chamber 22c, a mechanical oil pump 31, an electric oil pump 32, a check valve 33, a line pressure regulating valve 34, a line pressure solenoid 35, a switching valve 36, an oil reservoir 37, a pilot valve 38, a clutch pressure solenoid 39, a clutch 40, and a T/C hydraulic system 41. These configurations form the hydraulic circuit 3 jointly with oil passages as follows.

The PRI pulley oil chamber 21c and the SEC pulley oil chamber 22c communicate with each other via a first oil passage R1. The mechanical oil pump 31 is connected to the first oil passage R1 via a discharge side oil passage Rout of the mechanical oil pump 31. The mechanical oil pump 31 is a mechanical oil pump driven by the power of the engine ENG and, as schematically illustrating a coupling state by a two-dot chain line, is coupled to an impeller of the torque converter TC via a power transmission member.

The check valve 33 is provided in the discharge side oil passage Rout. The check valve 33 blocks the flow of the oil in the direction toward the mechanical oil pump 31 and allows the flow of the oil in the opposite direction. The line pressure regulating valve 34 is connected to the discharge side oil passage Rout at a portion downstream of the check valve 33.

The line pressure regulating valve 34 adjusts the pressure of the oil supplied from the mechanical oil pump 31 to a line pressure PL. The line pressure regulating valve 34 is operated according to a solenoid pressure generated by the line pressure solenoid 35. In this embodiment, the line pressure PL is supplied as the SEC pressure Psec to the SEC pulley oil chamber 22c.

The electric oil pump 32 and the switching valve 36 are provided in the first oil passage R1. The electric oil pump 32 is provided in the first oil passage R1 at a portion located more on the PRI pulley oil chamber 21c side than a first point C1 to which the discharge side oil passage Rout is connected. The electric oil pump 32 can be rotated in forward and reverse rotation directions. Specifically, the forward rotation direction is defined as a direction that causes the oil to be supplied to the PRI pulley oil chamber 21c side, and the reverse rotation direction is defined as a direction that causes the oil to be supplied to the SEC pulley oil chamber 22c side.

The switching valve 36 is provided in the first oil passage R1 at a portion between the electric oil pump 32 and the PRI pulley oil chamber 21c. The switching valve 36 has a first position P1 and a second position P2 as switching positions and is configured to be able to switch between the first position P1 and the second position P2. The switching positions of the switching valve 36 will be described later.

The electric oil pump 32 communicates with the oil reservoir 37 via a second oil passage R2. Specifically, the second oil passage R2 is connected to a strainer 37a in the oil reservoir 37. The second oil passage R2 includes an oil passage communicating between the oil reservoir 37 and the switching valve 36, and a portion of the first oil passage R1 between the switching valve 36 and the electric oil pump 32. The former oil passage is configured as an oil passage not including other oil passages connected to the switching valve 36. The switching valve 36 is provided to connect these oil passages, thus resulting in that the switching valve 36 is provided further in the second oil passage R2.

Specifically, the second oil passage R2 is connected to an oil inlet/outlet port 32a of the electric oil pump 32 on the PRI pulley oil chamber 21c side. The portion of the first oil passage R1 between the switching valve 36 and the electric oil pump 32 serves as a part of the second oil passage R2. The mechanical oil pump 31 is also connected, via a suction side oil passage Rin, to the second oil passage R2 at a portion located more on the oil reservoir 37 side than the switching valve 36.

The second oil passage R2 and the switching valve 36 described above can be grasped as follows. That is, the second oil passage R2 can be grasped as an oil passage branching from the first oil passage R1 between the electric oil pump 32 and the PRI pulley oil chamber 21c and communicating with the oil reservoir 37. The switching valve 36 can be grasped as a switching valve provided at a branch point of the first oil passage R1 and the second oil passage R2.

The oil reservoir 37 is an oil reservoir storing the oil to be supplied by the mechanical oil pump 31 and the electric oil pump 32, and the oil is sucked from the oil reservoir 37 through the strainer 37a. The oil reservoir 37 may be composed of a plurality of oil reservoirs.

The electric oil pump 32 communicates with the clutch 40, specifically a clutch oil chamber 40a of the clutch 40, via a clutch oil passage R_{CL}. The clutch oil passage R_{CL} includes a portion of the first oil passage R1 between the electric oil pump 32 and a second point C2. The second point C2 is a point in the first oil passage R1 between the electric oil pump 32 and the first point C1. The clutch oil passage R_{CL} further includes an oil passage communicating between the second point C2 and the clutch 40.

Specifically, the clutch oil passage R_{CL} is connected to an oil inlet/outlet port 32b of the electric oil pump 32 on the SEC pulley oil chamber 22c side. The portion of the first oil passage R1 between the electric oil pump 32 and the second point C2 serves as a part of the clutch oil passage R_{CL}. The clutch oil passage R_{CL} is configured as an oil passage not including the second oil passage R2.

The clutch 40 is engaged by supplying the oil to the clutch oil chamber 40a and disengaged by draining the oil from the clutch oil chamber 40a. The clutch 40 performs the power transmission between the engine ENG and the drive wheels jointly with the variator 2. The clutch 40 connects and disconnects the power transmission path connecting the engine ENG and the drive wheels. The clutch 40 forms a hydraulic device other than the variator 2.

The pilot valve 38 is provided in the clutch oil passage R_{CL} at a portion branching from the first oil passage R1. The clutch pressure solenoid 39 is provided in the clutch oil passage R_{CL} at a portion between the pilot valve 38 and the clutch 40. The pilot valve 38 reduces the pressure of the oil supplied from the first oil passage R1. The clutch pressure solenoid 39 adjusts the supply oil pressure to the clutch 40, i.e. an oil pressure P_{CL} in the clutch oil chamber 40a.

Further, a PRI oil passage R_{PRI} branches from the clutch oil passage R_{CL} and communicates with the PRI pulley oil chamber 21c. The PRI oil passage R_{PRI} includes an oil passage communicating between the clutch oil passage R_{CL} and the switching valve 36, and a portion of the first oil passage R1 between the switching valve 36 and the PRI pulley oil chamber 21c. The former oil passage is configured as an oil passage not including other oil passages connected to the switching valve 36. The switching valve 36 is provided to connect these oil passages, thus resulting in that the switching valve 36 is provided further in the PRI oil passage R_{PRI}.

Specifically, the PRI oil passage R_{RPI} branches from the clutch oil passage R_{CL} at a portion between the clutch pressure solenoid 39 and the clutch 40. The portion of the first oil passage R1 between the PRI pulley oil chamber 21c and the switching valve 36 serves as a part of a third oil passage R3.

The PRI oil passage Rpm described above, along with a part of the clutch oil passage R_{CL} (specifically, the clutch oil passage R_{CL} between the second point C2 and the point from which the PRI oil passage R_{PRI} branches), can be grasped as the third oil passage R3 branching from the first oil passage R1 between the electric oil pump 32 and the SEC pulley oil chamber 22c and reaching the switching valve 36.

In addition, in the hydraulic circuit 3, oil passages are provided that branch from the clutch oil passage R_{CL} at a portion between the pilot valve 38 and the clutch pressure solenoid 39 and are respectively connected to the line pressure solenoid 35 and the T/C hydraulic system 41.

The line pressure solenoid 35 generates a solenoid pressure corresponding to a command value of the line pressure PL and supplies it to the line pressure regulating valve 34. The T/C hydraulic system 41 is a hydraulic system for the torque converter TC including the lockup clutch LU, and the oil drained from the line pressure regulating valve 34 is also supplied to the T/C hydraulic system 41.

In the hydraulic circuit 3 thus configured, the mechanical oil pump 31 supplies the SEC pressure Psec to the SEC pulley oil chamber 22c, and the electric oil pump 32 controls the supply and discharge of the oil to and from the PRI pulley oil chamber 21c. The mechanical oil pump 31 is used for holding the belt 23, and the electric oil pump 32 is used for the shift.

That is, as the shift principle, the shift is performed by moving the oil from one of the PRI pulley oil chamber 21c and the SEC pulley oil chamber 22c to the other by the electric oil pump 32.

A controller 10 is further provided in the vehicle. The controller 10 is configured by including a transmission controller 11 and an engine controller 12.

Signals from a rotation sensor 51 for detecting a rotation speed of the variator 2 on the input side, a rotation sensor 52 for detecting a rotation speed of the variator 2 on the output side, a pressure sensor 53 for detecting a PRI pressure Ppri being an oil pressure in the PRI pulley oil chamber 21c, and a pressure sensor 54 for detecting a SEC pressure Psec are input to the transmission controller 11. The rotation sensor 51 specifically detects a rotation speed Npri of the PRI pulley 21. The rotation sensor 52 specifically detects a rotation speed Nsec of the SEC pulley 22. The transmission controller 11 can detect a vehicle speed VSP based on the input from the rotation sensor 52.

Further, signals from an accelerator pedal opening sensor 55, a brake sensor 56, a selected range detection switch 57, an engine rotation sensor 58, an oil temperature sensor 59, and an oil pressure sensor 60 are input to the transmission controller 11.

The accelerator pedal opening sensor 55 detects an accelerator pedal opening APO indicative of an operation amount of an accelerator pedal. The brake sensor 56 detects a brake pedal depression force BRK. The selected range detection switch 57 detects a range RNG selected by a shift lever being a selector. The engine rotation sensor 58 detects a rotation speed Ne of the engine ENG. The oil temperature sensor 59 detects an oil temperature T_{OIL} of the transmission 1. The oil temperature T_{OIL} is the temperature of the oil used as the hydraulic oil in the variator 2. The oil pressure sensor 60 detects an oil pressure P_{CL}.

The transmission controller 11 is connected to the engine controller 12 so as to be communicable with each other. Engine torque information Te is input from the engine controller 12 to the transmission controller 11. The signals from the accelerator pedal opening sensor 55 and the engine rotation sensor 58 may be input to the transmission controller 11, for example, via the engine controller 12.

The transmission controller 11 generates control signals including a shift control signal based on the input signals and outputs the generated control signals to the hydraulic circuit 3. In the hydraulic circuit 3, the electric oil pump 32, the line pressure solenoid 35, the switching valve 36, the clutch pressure solenoid 39, and so on are controlled based on the control signals from the transmission controller 11. Consequently, for example, the speed ratio of the variator 2 is controlled to a speed ratio corresponding to the shift control signal, i.e. a target speed ratio.

In this embodiment, the controller 10 configured by including the transmission controller 11 and the engine controller 12 forms a power transmission device jointly with the transmission 1.

Next, the switching positions of the switching valve 36 will be described.

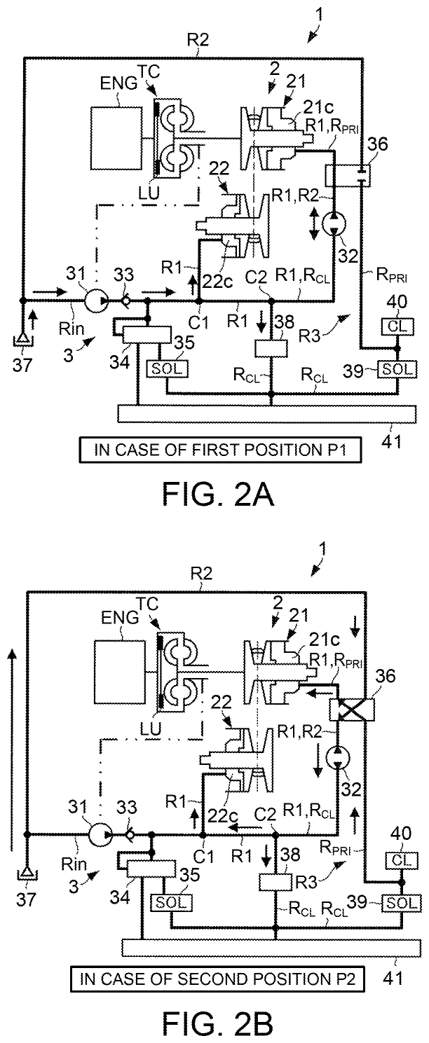

FIGS. 2A and 2B are explanatory diagrams of the switching positions of the switching valve 36. FIG. 2A illustrates the case in which the switching position, i.e. the valve position, is the first position P1, and FIG. 2B illustrates the case in which the switching position is the second position P2.

As illustrated in FIG. 2A, the first position P1 is the switching position that sets the first oil passage R1 to a communicating state and the second oil passage R2 to a blocked state. Further, in the first position P1, the PRI oil passage Rpm is set to a blocked state. As a result, in the case of the first position P1, the mechanical oil pump 31 supplies the oil in the oil reservoir 37 to the SEC pulley oil chamber 22c and the clutch 40, and the electric oil pump 32 controls the supply and discharge of the oil to and from the PRI pulley oil chamber 21c.

As illustrated in FIG. 2B, the second position P2 is the switching position that sets the first oil passage R1 to a blocked state and the second oil passage R2 to a communicating state. Further, in the second position P2, the PRI oil passage R_{PRI} is set to a communicating state. As a result, in the case of the second position P2, the electric oil pump 32 communicates with the clutch 40 and the PRI pulley oil chamber 21c and supplies the oil in the oil reservoir 37 to the clutch 40 and the PRI pulley oil chamber 21c.

Further, in the case of the second position P2, the oil in the clutch oil passage R_{CL} can be adjusted in pressure by the clutch pressure solenoid 39 and supplied to the PRI pulley oil chamber 21c. Therefore, even when the first oil passage R1 is blocked by the switching valve 36, the shift of the variator 2 is enabled.

The clutch pressure solenoid 39 forms a pressure regulating valve for adjusting the pressure of the oil to be supplied to the clutch 40, and forms a pressure regulating portion for adjusting the oil pressure in the PRI oil passage R_{PRI}. The PRI oil passage R_{PRI} and the clutch pressure solenoid 39 form a PRI pressure supply portion that allows the oil in the clutch oil passage R_{CL} to be adjusted in pressure and supplied to the PRI pulley oil chamber 21c.

The oil in the clutch oil passage R_{CL} is adjusted to a predetermined oil pressure PA by the PRI oil passage R_{PRI} and the clutch pressure solenoid 39 forming the PRI pressure supply portion. The predetermined oil pressure PA is, for example, a command pressure of the PRI pressure Ppri, and the PRI pressure Ppri supplied at the time of a shift is greater than an engagement pressure of the clutch 40. Therefore, in the second position P2, it is possible to perform the shift of the variator 2 while maintaining the clutch 40 in an engaged state.

The switching valve 36 described above can be grasped as follows, in addition to the fact that the second oil passage R2 and the switching valve 36 can be grasped as described above. That is, the switching valve 36 can be grasped as a switching valve that switches between the two positions, i.e. the first position P1 that causes at least the first oil passage R1 to be in a communicating state, and the second position P2 that causes the second oil passage R2 and the first oil passage R1 on the SEC pulley oil chamber 22c side to be in a state of communicating with each other and causes the third oil passage R3 and the first oil passage R1 on the PRI pulley oil chamber 21c side to be in a state of communicating with each other.

The clutch pressure solenoid 39, in other words, can be grasped as a pressure regulating portion provided in the third oil passage R3 to adjust the oil pressure in the third oil passage R3 between the clutch pressure solenoid 39 and the switching valve 36.

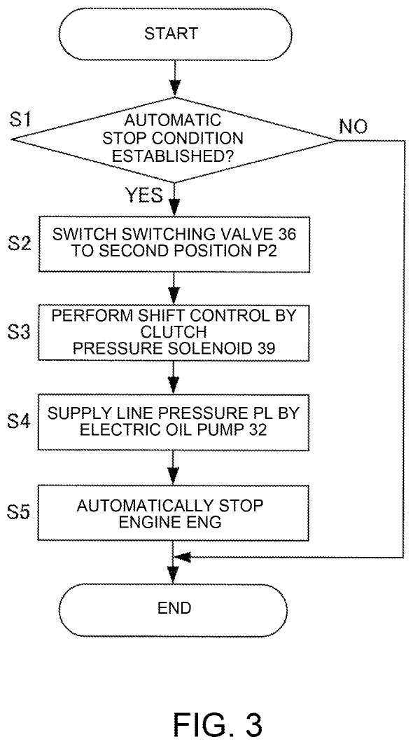

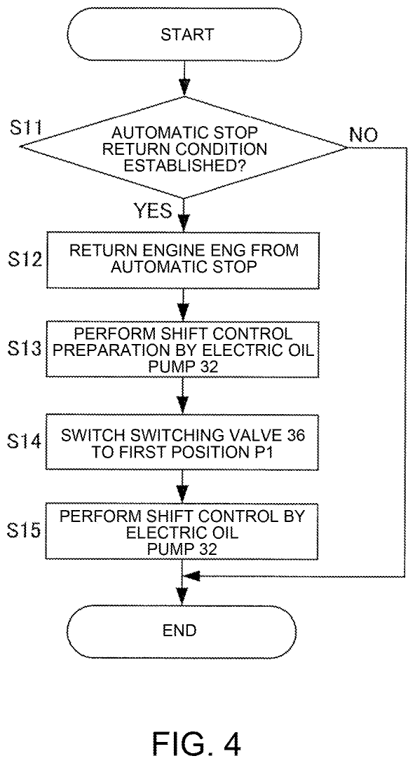

Next, control that is performed by the controller 10 in this embodiment will be described with reference to FIGS. 3 and 4.

FIG. 3 is a diagram in the form of a flowchart illustrating one example of control at the time of automatic stop of the engine ENG. When performing the processings of this flowchart, the controller 10 can be configured, for example, such that the engine controller 12 performs the processings of steps S1 and S5, and that the transmission controller 11 performs the other processings.

At step S1, the controller 10 determines whether or not an automatic stop condition of the engine ENG is established. The automatic stop condition of the engine ENG is, for example, an idle stop condition. The idle stop condition includes, for example, that the vehicle speed VSP is zero, that the accelerator pedal is not depressed, that the brake pedal is depressed, and that the selected range is a permissive range that permits the performance of idle stop. When the determination is negative at step S1, the processings once end, and when the determination is affirmative at step S1, the processings proceed to step S2.

At step S2, the controller 10 sets the switching position of the switching valve 36 to the second position P2. Consequently, when the automatic stop condition of the engine ENG is established, the switching valve 36 is set to the second position P2. At step S2, shift control by the electric oil pump 32 is also stopped.

At step S3, the controller 10 performs shift control by the clutch pressure solenoid 39. In this event, the controller 10 adjusts the pressure of the oil in the clutch oil passage R_{CL} to the predetermined oil pressure PA by the clutch pressure solenoid 39. Consequently, the oil adjusted to the predetermined oil pressure PA is supplied to the PRI pulley oil chamber 21c.

At step S4, the controller 10 supplies the line pressure PL by the electric oil pump 32. Consequently, when the automatic stop condition of the engine ENG is established, the oil in the oil reservoir 37 is supplied to the clutch 40 by the electric oil pump 32.

At step S5, the controller 10 automatically stops the engine ENG. After step S5, the processings once end.

FIG. 4 is a diagram in the form of a flowchart illustrating one example of control at the time of automatic stop return of the engine. When performing the processings of this flowchart, the controller 10 can be configured, for example, such that the engine controller 12 performs the processings of steps S11 and S12, and that the transmission controller 11 performs the other processings.

At step S11, the controller 10 determines whether or not an automatic stop return condition of the engine ENG is established. The automatic stop return condition of the engine ENG is defined such that its establishment and non-establishment conditions are opposite to those of the automatic stop condition of the engine. When the determination is negative at step S11, the processings once end, and when the determination is affirmative at step S11, the processings proceed to step S12.

At step S12, the controller 10 returns the engine ENG from the automatic stop. Consequently, the mechanical oil pump 31 is driven so that it is possible to supply the line pressure PL by the mechanical oil pump 31.

At step S13, the controller 10 performs a shift control preparation by the electric oil pump 32. In the shift control preparation, the rotation direction of the electric oil pump 32 is switched from the reverse rotation direction to the forward rotation direction before switching the switching valve 36. Consequently, the PRI pressure Ppri is prevented from decreasing at the time of switching the switching valve 36.

At step S14, the controller 10 sets the switching position of the switching valve 36 to the first position P1. Consequently, when the automatic stop return condition of the engine ENG is established, i.e. when the automatic stop condition of the engine ENG is non-established, the switching valve 36 is set to the first position P1.

At step S15, the controller 10 performs shift control by the electric oil pump 32. Consequently, when the automatic stop condition of the engine ENG is non-established, the supply and discharge of the oil to and from the PRI pulley oil chamber 21c is controlled by the electric oil pump 32. After step S15, the processings once end.

By being configured to perform the processings of step S5 and further the processings of step S12, the controller 10 is configured to include a drive source stop control unit. Further, by being configured to perform the processings of steps S2 and S14, the controller 10 is configured to include a switching valve control unit. By being configured to perform the processings of steps S4 and S15 and further the processings of step S13, the controller 10 is configured to include an oil pump control unit.

Next, the main operations and effects of the power transmission device according to this embodiment will be described.

The power transmission device according to this embodiment includes the variator 2, the first oil passage R1 communicating between the PRI pulley oil chamber 21c and the SEC pulley oil chamber 22c, the electric oil pump 32 provided in the first oil passage R1, the second oil passage R2 branching from the first oil passage R1 between the electric oil pump 32 and the PRI pulley oil chamber 21c and communicating with the oil reservoir 37, the switching valve 36 provided at the branch point of the first oil passage R1 and the second oil passage R2, and the third oil passage R3 branching from the first oil passage R1 between the electric oil pump 32 and the SEC pulley oil chamber 22c and reaching the switching valve 36. The switching valve 36 switches between the two positions, i.e. the first position P1 that causes at least the first oil passage R1 to be in the communicating state, and the second position P2 that causes the second oil passage R2 and the first oil passage R1 on the SEC pulley oil chamber 22c side to be in the state of communicating with each other and causes the third oil passage R3 and the first oil passage R1 on the PRI pulley oil chamber 21c side to be in the state of communicating with each other.

With this configuration, even when the oil in the oil reservoir 37 is supplied to the clutch 40 by the electric oil pump 32, the oil in the oil reservoir 37 can be supplied to the PRI pulley oil chamber 21c through the second oil passage R2 and the third oil passage R3 in the second position P2. Therefore, with this configuration, even when the first oil passage R1 is blocked by the switching valve 36 in such a case, the shift of the variator 2 is enabled. As a result, for example, the speed ratio of the variator 2 can be properly set during the automatic stop of the engine ENG so that the starting performance or the re-acceleration performance of the vehicle is improved.

The controller 10 is configured to stop the engine ENG when the automatic stop condition of the engine ENG is established. The controller 10 is configured to set the switching position of the switching valve 36 to the first position P1 when the automatic stop return condition of the engine ENG is established, i.e. when the automatic stop condition of the engine ENG is non-established, and to set the switching position of the switching valve 36 to the second position P2 when the automatic stop condition of the engine ENG is established.

With this configuration, it is possible to properly switch the switching position of the switching valve 36 according to the automatic stop of the engine ENG.

The controller 10 is configured to control the supply and discharge of the oil to and from the PRI pulley oil chamber 21c by the electric oil pump 32 when the automatic stop condition of the engine ENG is non-established, and to supply the oil in the oil reservoir 37 to the clutch 40 by the electric oil pump 32 when the automatic stop condition of the engine ENG is established.

With this configuration, the shift of the variator 2 can be performed as usual by the electric oil pump 32 while the engine ENG is operated, and further, the shift of the variator 2 is enabled even while the engine ENG is stopped.

In this embodiment, the PRI pressure supply portion that allows the oil in the clutch oil passage R_{CL} to be adjusted in pressure and supplied to the PRI pulley oil chamber 21c is configured to include the clutch pressure solenoid 39 as the pressure regulating portion that is provided in the third oil passage R3 to adjust the oil pressure in the PRI oil passage R_{PRI}, specifically in the third oil passage R3 between the clutch pressure solenoid 39 and the switching valve 36.

With this configuration, the shift of the variator 2 is enabled by the adjustment of the oil pressure in the PRI oil passage R_{PRI}.

The clutch pressure solenoid 39 as the pressure regulating portion that adjusts the oil pressure in the PRI oil passage R_{PRI} is the pressure regulating valve that adjusts the pressure of the oil to be supplied to the clutch 40.

With this configuration, since the clutch pressure solenoid 39 through which the oil is passed when supplied to the clutch 40 can be used as the pressure regulating portion that adjusts the oil pressure in the PRI oil passage R_{PRI}, it is advantageous in view of the cost.

The pressure regulating portion that adjusts the oil pressure in the PRI oil passage R_{PRI} may be a pressure regulating valve different from the clutch pressure solenoid 39.

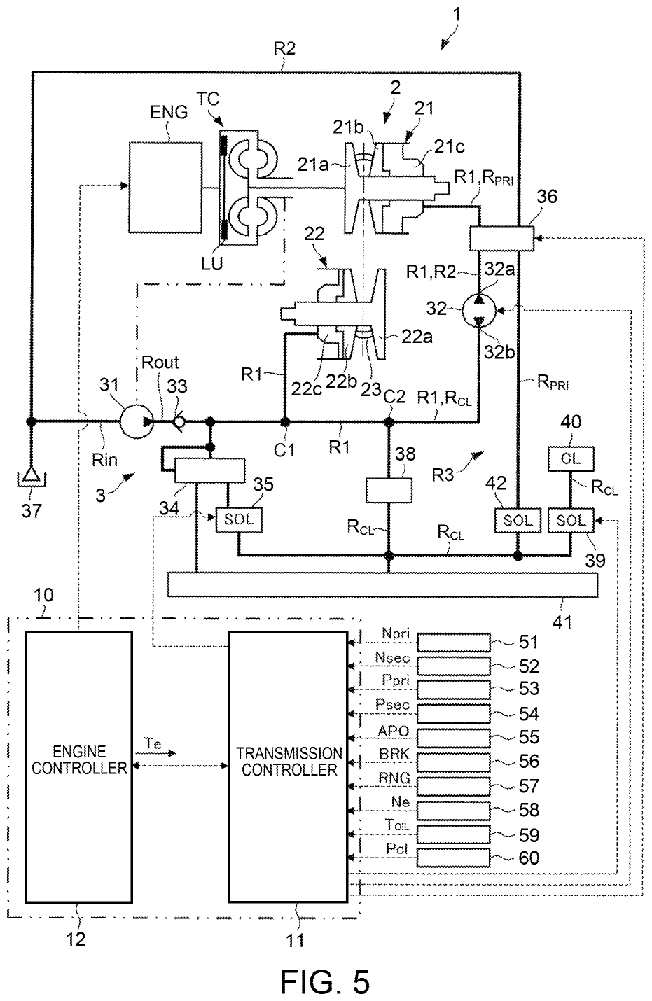

FIG. 5 is a diagram illustrating a modification of a power transmission device. In this example, the PRI oil passage R_{PRI} is provided to branch from the clutch oil passage R_{CL} at a portion between the pilot valve 38 and the clutch pressure solenoid 39. A PRI pressure solenoid 42 is provided in the PRI oil passage Rpm. The PRI pressure solenoid 42 is a pressure regulating valve for adjusting the pressure of the oil to be supplied to the PRI pulley oil chamber 21c and is provided in the PRI oil passage R_{PRI} at a portion between the switching valve 36 and the clutch oil passage R_{CL}.

With this configuration, the supply oil pressure to the PRI pulley oil chamber 21c can be adjusted independently of the supply oil pressure to the clutch 40. Therefore, the pressure adjustment using the predetermined oil pressure PA as a command pressure of the PRI pressure Ppri can be performed without being limited by the control of the clutch 40 so that the shift controllability is improved.

While the embodiment of the present invention has been described above, the above-described embodiment only shows part of application examples of the present invention and is not intended to limit the technical scope of the present invention to the specific configurations of the above-described embodiment.

In the above-described embodiment, the description has been given of the case in which the engine ENG is stopped under the idle stop condition as the predetermined condition. However, the predetermined condition may be, for example, a coast stop condition. The coast stop condition includes that the vehicle speed VSP is less than a predetermined vehicle speed, that the accelerator pedal is not depressed, that the brake pedal is depressed, and that the forward range is selected. The predetermined vehicle speed is, for example, a vehicle speed at which the lockup clutch LU is disengaged.

In the above-described embodiment, the description has been given of the case in which the controller 10 including the transmission controller 11 and the engine controller 12 performs the control. However, it may be configured that, for example, a single controller performs the control.

This application claims priority to Patent Application No. 2017-254753 filed with the Japanese Patent Office on Dec. 28, 2017, the entire contents of which are incorporated into this specification by reference.

1.-6. (canceled)

7. A power transmission device comprising:
a continuously variable transmission mechanism configured to perform power transmission between a drive source and a drive wheel;
a first oil passage communicating between a primary pulley oil chamber of the continuously variable transmission mechanism and a secondary pulley oil chamber of the continuously variable transmission mechanism;
an electric oil pump provided in the first oil passage;
a second oil passage branching from the first oil passage between the electric oil pump and the primary pulley oil chamber and communicating with an oil reservoir;
a switching valve provided at a branch point of the first oil passage and the second oil passage; and
a third oil passage branching from the first oil passage between the electric oil pump and the secondary pulley oil chamber and reaching the switching valve,
wherein the switching valve is configured to switch between two positions, the two positions being a first position that causes at least the first oil passage to be in a communicating state, and a second position that causes the second oil passage and the first oil passage on a secondary pulley oil chamber side to be in a state of communicating with each other and causes the third oil passage and the first oil passage on a primary pulley oil chamber side to be in a state of communicating with each other.

8. The power transmission device according to claim 7, comprising a controller configured to stop the drive source when a predetermined condition is established, and configured to set a switching position of the switching valve to the first position when the predetermined condition is non-established, and to set the switching position of the switching valve to the second position when the predetermined condition is established.

9. The power transmission device according to claim 8, wherein the controller is configured to control supply and discharge of oil to and from the primary pulley oil chamber by the electric oil pump when the predetermined condition is non-established, and to supply oil in the oil reservoir to a hydraulic device other than the continuously variable transmission mechanism by the electric oil pump when the predetermined condition is established.

10. The power transmission device according to claim 7, further comprising a primary pressure supply portion configured to include a pressure regulating portion provided in the third oil passage to adjust an oil pressure in the third oil passage between the pressure regulating portion and the switching valve.

11. The power transmission device according to claim 10, wherein the pressure regulating portion is a pressure regulating valve configured to adjust a pressure of the oil to be supplied to the hydraulic device other than the continuously variable transmission mechanism.

12. The power transmission device according to claim 10, wherein the pressure regulating portion is a pressure regulating valve different from a pressure regulating valve configured to adjust a pressure of the oil to be supplied to the hydraulic device other than the continuously variable transmission mechanism.

13. The power transmission device according to claim 8, further comprising a primary pressure supply portion configured to include a pressure regulating portion provided in the third oil passage to adjust an oil pressure in the third oil passage between the pressure regulating portion and the switching valve.

14. The power transmission device according to claim 9, further comprising a primary pressure supply portion configured to include a pressure regulating portion provided in the third oil passage to adjust an oil pressure in the third oil passage between the pressure regulating portion and the switching valve.
